(19) United States
(12) Patent Application Publication
(10) Pub. No.: US 2016/0197773 A1
(43) Pub. Date: Jul. 7, 2016

(54) TECHNIQUES FOR SHARING APPLICATIONS

(71) Applicant: Kii, Inc., San Mateo, CA (US)

(72) Inventors: Phani Pandrangi, San Jose, CA (US); Makoto Iguchi, Tokyo (JP); Susumu Ishizuka, Tokyo (JP)

(73) Assignee: Kii, Inc., San Mateo, CA (US)

(21) Appl. No.: 14/989,282

(22) Filed: Jan. 6, 2016

Related U.S. Application Data
(60) Provisional application No. 62/100,608, filed on Jan. 7, 2015.

(51) Int. Cl. H04L 12/24; H04L 29/08

(52) U.S. Cl. CPC H04L 41/0803; H04L 67/06; H04L 67/10

(57) ABSTRACT

Techniques that enable a user of an application to refer or share the application with another user and for onboarding the new user to the referred or shared application. In certain embodiments, the application to be shared is automatically downloaded and installed on the other user's device. As part of the sharing or onboarding of the other user, configuration data for the application is also automatically downloaded to the other user's device and applied to the application, where the downloaded configuration data includes one or more customized configuration settings reflecting one or more customizations made to the application due to the first or original user's interactions with the application on the first user's device.

### CROSS-REFERENCES TO RELATED APPLICATIONS

This application is a non-provisional application and claims the benefit and priority of U.S. Provisional Application No. 62/100,608, filed on Jan. 7, 2015 titled “METHOD AND SYSTEM FOR APP REFERRAL BASED QUICK ONBOARDING,” which is herein incorporated by reference in its entirety for all purposes.

### BACKGROUND

The present disclosure generally relates to the field of computing systems; and more specifically to techniques for enabling a user to refer or share an application with another user.

The downloading of software applications to computing systems (e.g., smartphones, tablets, etc.) has become quite ubiquitous. While downloading of applications has become quite simple, configuring or customizing a downloaded application to meet the user's needs still presents significant challenges to many users. For example, a user of a mobile device such as a smartphone may need to customize an application downloaded to the smartphone to suit the user's needs. The customization could be as simple as changing the color scheme used by the application, changing the default search engine used by a browser application, changing the default home page of a browser application, adding cities to a weather application, and the like to more complex customizations. Such customizations are generally made by making changes to the application's configuration data. However, in order to make such customizations, the user has to know how the application works and how to make the customizations. In other words, the user has to be sufficiently technically savvy because any incorrect changes to an application's configuration data can have unintended and undesired impacts on the application. Accordingly, while most users are comfortable with downloading applications, they are very scared of making any changes or customizations to the application.

### SUMMARY

The present disclosure describes techniques that enable a user of an application to refer or share the application with another user and for onboarding the new user to the referred or shared application. In certain embodiments, the application to be shared is automatically downloaded and installed on the other user's device. As part of the sharing or on-boarding of the other user, configuration data for the application is also automatically downloaded to the other user's device and applied to the application, where the downloaded configuration data includes one or more customized configuration settings reflecting one or more customizations made to the application due to the first or original user's interactions with the application on the first user's device.

Some embodiments can facilitate the onboarding of new users to an application. In certain embodiments, a user (first user) request to share an application and/or its current configuration settings with another user (second user) can be received by an application sharing system. For example, without limitation, the user request can be received by the application sharing system when a user performs a gesture input (e.g., a flick motion, a hold-and-swipe motion) on an application icon on the user's home screen. The user request can be a unique gesture such as a long hold and swipe gesture in a particular region of the screen. The user request

The application sharing system can include one or more servers such as an application management server and/or an application configuration management server. The one or more servers can be configured to maintain user accounts associated with users of the application sharing system. After receiving the user request to share an application and/or its current configuration settings, the application sharing system can send information related to the user request to a computing device associated with the second user. In certain embodiments, the information communicated to the second device may include information identifying the application, information identifying the first user who desires to share the application with the second user, and information indicating to the second user that the first user has indicated a desire to refer or share the application with the second user.

The application sharing system can receive an acknowledgement from the computing device associated with the second user whether the second user has accepted or denied the user request by the first user. In the event where the second user accepts the user request, the application can be downloaded to the computing device of the second user if the computing device does not have the application installed already, and the configuration data can also be downloaded to the computing device of the second user. The application sharing system can then cause the configuration data to be applied to the application on the computing device of the second user. Subsequently, the configuration data of the application on the computing device of the first user and the configuration data of the application on the computing device of the second user can be modified by the first user and the second user independently on their respective computing devices.

In exemplary implementations, after the user request has been received, a copy of the configuration data of the application can be created for the second user and copied to a user account of the second user. In one implementation, an operating system on the computing device of a second user can be configured to automatically download the copy of the configuration data of the application after the copy of the configuration data of the application is created for the second user on the application sharing system. In some embodiments, the second user may be facilitated to accept or deny the downloading of the copy of the configuration data of the application. In some embodiments, the configuration data downloaded to the computing device of the second user can comprise default configuration data downloaded to the computing device when the application was downloaded to the computing device of the first user.

The details of one or more embodiments of the invention are set forth in the accompanying drawings and the description below. Other features, objects, and advantages of the invention will be apparent from the description and drawings, and from the claims.

The foregoing, together with other features and embodiments, will become more apparent upon referring to the following specification, claims, and accompanying drawings.

### BRIEF DESCRIPTION OF THE DRAWINGS

FIG. 1 shows a simplified block diagram of a computing environment for facilitating sharing of an application and its associated configuration data between users in accordance with an embodiment of the present invention.

FIG. 2 illustrates an example flowchart illustrating processing performed by an application sharing system for sharing an application and associated configuration data in accordance with some embodiments of the present invention.

FIG. 3 illustrates another example flowchart illustrating processing performed for sharing an application and its associated configuration data including one or more customized configuration settings in accordance with some embodiments of the present invention.

FIG. 4 is a sequence chart illustrative of a process for sharing an application in accordance with certain embodiments.

FIG. 5 illustrates an example flowchart for processing performed for sharing an application from the perspective of a device of the user receiving the application (i.e., the recipient of the application sharing) in accordance with certain embodiments of the present invention.

FIG. 6 is a sequence chart illustrative of a process for accepting an application sharing request originated by a first user (e.g., User A) at second user's (e.g., User B) device in accordance with certain embodiments.

FIG. 7 illustrates an example of how a first user of a first device may refer or share an application on the first device and its associated customized configuration data with a second user in accordance with certain embodiments of the present invention.

FIG. 8 illustrates an example of processing performed from the perspective of a user receiving an application and its associated configuration data as a result of a sharing request generated by another user in accordance with certain embodiments of the present invention.

FIG. 9 illustrates an example that a recipient user is able to make his/her own configuration changes for an application independent of the sharing user according to certain embodiments of the present invention.

FIG. 10 is a simplified block diagram of a computer system that may be used in according with certain embodiments of the present invention

### DETAILED DESCRIPTION

In the following description, for the purposes of explanation, specific details are set forth in order to provide a thorough understanding of the exemplary embodiments. However, it will be apparent that various embodiments may be practiced without these specific details. For example, circuits, systems, algorithms, structures, techniques, networks, processes, and other components may be shown as components in block diagram form in order not to obscure the embodiments in unnecessary detail. The figures and description are not intended to be restrictive.

The present disclosure describes techniques that enable a user of an application to refer or share the application with another user and for onboarding the new user to the referred or shared application. In certain embodiments, the application to be shared is automatically downloaded and installed on the other user's device. As part of the sharing or on-boarding of the other user, configuration data for the application is also automatically downloaded to the other user's device and applied to the application, where the downloaded configuration data includes one or more customized configuration settings reflecting one or more customizations made to the application due to the first or original user's interactions with the application on the first user's device.

Certain embodiments are directed to techniques (e.g., a system, a method, a memory or non-transitory computer readable medium storing code or instructions executable by one or more processors) that enable configuration changes or customizations made to the application by the referring user to be communicated to the new user and applied to the application for the new user as part of the onboarding process. In this manner, configuration changes made by the referring user are provided and shared with the new user.

In certain embodiments, a first user may have an application downloaded on the first user's computer system, such as on the first user's mobile device. Subsequent to the download, configuration changes may have been made to the application due to the first user's interactions with the application on the first user's device. At some later point in time, the first user may want to refer or share the application with another second user. An application sharing system is described for facilitating this sharing. In certain embodiments, the application sharing system manages the processing performed for enabling the application sharing. In one embodiment, the application sharing system receives the sharing request from the first user's device and sends information indicative of the referral or sharing request to a second device associated with the second user. Once the second user has provided authorization for the application to be shared with the second user, the application being shared is automatically downloaded to the second device of the second user. As part of the sharing or on-boarding of the second user, configuration data for the application is also automatically downloaded to the second user's device and applied to the application, where the downloaded configuration data includes one or more customized configuration settings reflecting one or more customizations made to the application due to the first user's interactions with the application on the first user's device. In this manner, the application installed on the second user's device now has the configuration changes made by the referring first user on the referring first user's device.

In certain embodiments, the second user is able to make additional changes, if desired, to the application on the second user's device's independent of the referring first user's use of the application on the referring first user's device. Likewise, the referring first user can make further changes configuration changes and customizations to the application on the referring first user's device independent of how the second user uses the application on the second user's device.

In certain embodiments, an application sharing system that facilitates the sharing of applications between users and that manages the on-boarding of new users for the shared applications may comprise one or more servers. The one or more servers may be configured to manage and store information related to users of applications. For example, for each user, the application sharing system may store information related to a user account. In certain embodiments, for each user, the associated user account information may include configuration data for the application for that user. The stored configuration data may include data representative of configuration changes and customizations made by the user to the application. In certain embodiments, the application sharing system enables a user to refer an application to a new user, and on-board the new user for the application including applying any configuration changes made to the application by the referring user to the application for the new user.

By enabling application referral and automatically on-boarding a new user to the application including applying the referring user's configuration changes and customizations to the application for the new user, the new user is relieved from having to make the configuration changes, a task that can be time-consuming and burdensome and require technical savviness. Certain embodiments can install an application referred by a user along with the application's configuration settings set by the user onto a new user's device automatically. In certain embodiments, upon detecting a share event (i.e., upon receiving a user input indicating a desire by a user to share an application on the user device), an operating system of the user device may send a request to an application sharing system to share the application with another user. The application sharing system in some embodiments may generate a copy of the configuration settings for the application set by the user and apply the configuration settings to a new copy of the application installed on the new user's device.

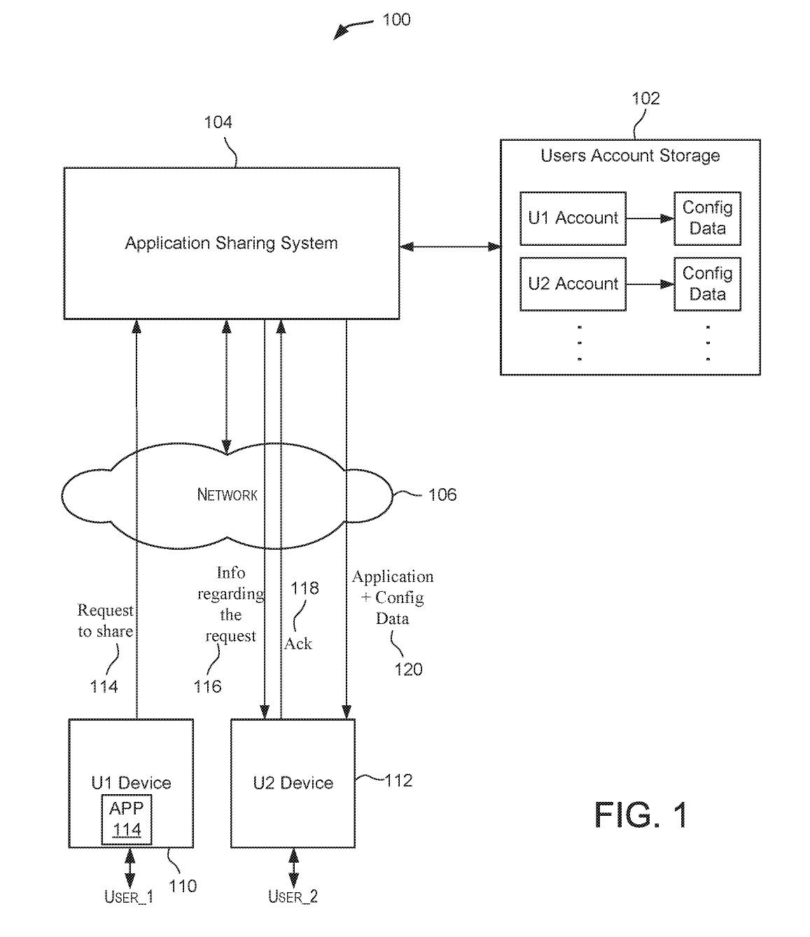

FIG. 1 shows a simplified block diagram of a computing environment 100 for facilitating sharing of an application and its associated configuration data between users in accordance with an embodiment of the present invention. As shown, computing environment 100 can include user computing devices, such as computing devices 110 and 112 shown in FIG. 1, an application sharing system 104, user account storage 102, and/or any other components. A given user computing device, for example computing device 110 or 112 can be communicatively coupled to application sharing system 104 via a communication network 106 as shown. The embodiment depicted in FIG. 1 is merely an example and is not intended to unduly limit the claimed embodiments of the present invention. One of ordinary skill in the art would recognize many variations, alternatives, and modifications.

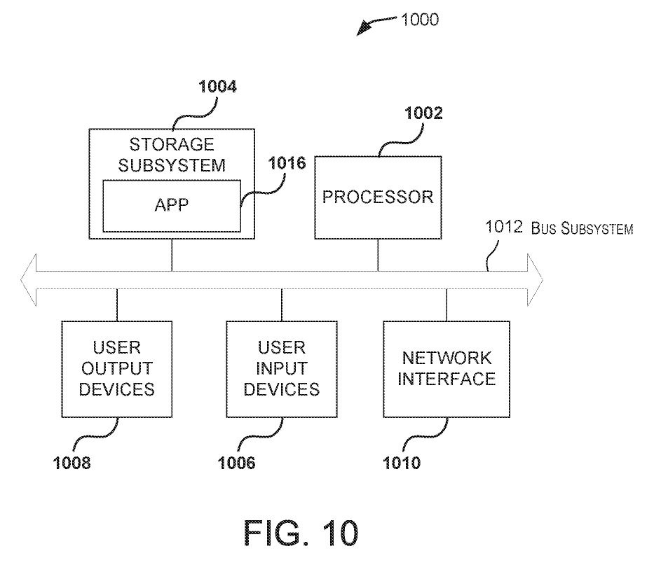

Client device 110 or 112 may be of various different types, including, but not limited to a personal computer, a desktop, a mobile or handheld device such as a laptop, a mobile phone, a tablet, a device that is part of an Internet or Things (IoT) network (e.g., a device with a sensor), etc., and other types of devices. A computing device 110 or 112 may include an input subsystem that a user of the device can use for providing inputs to the device. For example, in some instances, devices 110 or 112 may provide a touch sensitive surface that allows a user to provide input via user gestures. In some other instances, a device may include one or more user-selectable buttons for providing inputs. Computing devices 110 or 112 may also include an output subsystem that outputs information from the device to a user of the device. For example, the output subsystem may include a screen for displaying information. An example of a device 110 or 112 is depicted in FIG. 10 and described below.

There may be one or more applications accessible to a user (e.g., user 108) via a client device. For example, client device 110 can have one or more applications (e.g., application 114) stored, installed, and/or running on client device 110. A user of device 110 can interact with application 114, or with other applications made available by device 110, via input and output subsystems of device 110. In some instances, these interactions may be directed towards specifying configuration settings for configuration data associated with application 114, or other applications hosted by device 110.

In certain embodiments, application 114 may have associated configuration data comprising one or more configuration settings. In some embodiments, a configuration setting may comprise a configuration variable and a value assigned to the configuration variable. For example, an application may provide a font variable that controls the font used by the application and a value (e.g., Helvetica) may be assigned to that variable. The configuration data for application 114 may include one or more configuration settings.

In certain embodiments, the configuration data associated with an application influences and controls the behavior of that application. For a given application, the configuration data for the application can influence and control various aspects of the application such as, without restriction: the appearance (e.g., look and feel; e.g., background color, foreground color, etc.) of the given application, the application's logic (e.g., a specific starting screen, a specific arrangement and/or selection of contents), a region of the user (e.g., Northern America, Europe, etc.), a language (e.g., Chinese, English, Japanese) used by the given application, a time zone of the user of the device on which the given application is installed, font characteristics (e.g., font name, font size, font style) of the application, an others.

The configuration settings that make up the configuration data for an application may depend upon the application itself. For example, the configuration settings for one application may be the same as or different from the configuration settings for another application. For example, the configuration settings for a document editing application (e.g., Microsoft WORD™ application) may be different from the configuration settings for a game application. For example, the configuration data for the game application may include configuration settings for a difficulty level of the game, a sound level of the game, a mode of the game (e.g., “novice” mode, “expert” mode), and the like, which may be different from configuration settings associated with a document editing application.

Other examples of configuration data include without restriction, configuration settings pertaining to various display features including font type, size, color, object shapes, display configurations and orientations, item placements, etc.; settings pertaining to parameters and user-specified items saved in the application such as locations in a map application, weather application, travel application, clock application, favorites links saved in a browser application, news application, etc.; account data that may include personal information such as a user's address, credit card information, phone number, etc. to be used in an application; and the like. Configuration data for an application can also include different types of data, such as audio data (e.g., preferred tune when the phone rings), image or video data (e.g., a picture or video files that can be used as background images or videos in an application), and other types of data.

It should be appreciated that the configuration data for an application is to be distinguished from the application data, which is the actual data generated by the application and represents the output of the application. For example, for a document-editing application such as Microsoft WORD™, the contents of a document being edited using the application represent application data and is to be distinguished from configuration data for the application that controls or influences the behavior of the application. As another example, for a spreadsheet application such as Microsoft EXCEL™, the spreadsheet and its contents generated using the application represent application data and are to be distinguished from configuration data for the spreadsheet application that controls or influences the behavior of the application. As yet another example, in a game application, the actual data may include progress data keeping track of a user's progress in the game, while the configuration data of the game application may include a look and feel of the game, a difficulty level of the game, a sound level of the game, a mode of the game, and/or any other configuration information.

In certain embodiments, some of the configuration settings for an application may have been preconfigured by a system administrator, an application designer, and the like. For example, when application 114 is installed on a computing device (e.g., device 110), the application may have some associated configuration data with some preconfigured configuration settings. For purposes of this disclosure, the configuration data for an application that is communicated to a device which the application is first installed or loaded on the device is referred to as the application's default configuration data. As part of the default configuration data, some of the configuration settings may be set to default values while some other may not be set at all.

After application 114 has been stored and installed on device 110, changes may be made to the default configuration data as a result of interactions with application 114 by a user of device 110. The changes may include a change in a configuration setting from its default setting. For example, the default value associated with a configuration setting may be changed to a new value that is different from the default value. As another example, a configuration setting that was not set (i.e., was not assigned a value) as part of the default configuration data may now be set to a particular value. For purposes of this disclosure, configuration data for an application that is different from the default configuration data due to changes made to one or more configuration settings due to a user's interactions with application 114 on device 110 is referred to as user-configured configuration data or user-customized configuration data. A configuration setting whose value has been changed from its default setting is referred to as a user-configured configuration setting or user-customized configuration settings. The user-configured or customized configuration settings for application 114 may be stored locally at computing device 110, or, as described below, may be stored by application sharing system 104 as part of user account information for a user, or both. The configuration data for an application may be customized on a per user basis, a per user group basis, a domain-basis, or any other basis.

Communication network 106 can be any network or mechanism that facilitates data communications between one or more client devices such device 110 and 112 with application sharing system 104. In certain embodiments, communication network 106 may also facilitate communication between two or more client devices, such as between client devices 110 and 112. Communication network 106 can be of various types and can include one or more communication networks. For example, communication network 106 can include, without restriction, the Internet, a wide area network (WAN), a local area network (LAN), an Ethernet network, a public or private network, a wired network, a wireless network, and the like, and combinations thereof. Different communication protocols may be used to facilitate the communications including both wired and wireless protocols such as IEEE 802.XX suite of protocols, TCP/IP, IPX, SAN, AppleTalk, Bluetooth, and other protocols. In general, communication network 106 may include any communication network or infrastructure that facilitates communications between one or more client devices such as client device 110 or 112 and one or more servers in application sharing system 104.

In certain embodiments, application sharing system 104 is configured to facilitate the sharing of applications between devices. Application sharing system 104 may be configured to receive user requests and perform actions (e.g., serve content) in response thereto. Application sharing system 104 can include one or more servers. In certain embodiments, application sharing system 104 can include a server system for providing application download and another server system for managing the application configuration. Different embodiments may include additional or fewer servers for performing various actions.

In certain embodiments, application sharing system 104 can be configured to manage user accounts associated with users of one or more applications managed by application sharing system 104. Application sharing system 104 may store and manage information for multiple users for multiple applications. The information may be stored in a data store such as user account storage 102, which may be implemented using one or more non-volatile memories that are accessible and updatable by application sharing system 104. A data store can include any memory device or combination of devices capable of storing, accessing and retrieving data, which may include any combination and number of data servers, databases, data storage devices and data storage media, in any standard, distributed, or clustered environment. Data store 102 can represent one or more memory devices for data storage including one or more databases, lists, or other data structures. Application sharing system 104 can include any appropriate hardware and software for integrating with data store 102, as needed, to execute aspects of one or more applications for the client devices.

As indicated above, application sharing system 104 may be configured to store information for one or more users for one or more applications. In some embodiments, the information for users may be stored in the form of user accounts, such as User_1 account, User_2 account, and so on, with one user account per user. A particular user account managed by application sharing system 104 can include information regarding a particular user and information related to one or more applications downloaded and installed by the user on a user device. The user account information can include, for example, information related to the user's identity, one or more devices associated with the user, the user purchase information (e.g., purchase history of one or more applications and purchased by the user or purchase history of one or more items/services purchased by the user using the one or more applications), and/or any other type of user information. In some instances, the user identity information may include a user ID (e.g., a username) of the user. In some embodiments, user account information for a user may also include information related to user credentials or other authentication information for user verification and authorization.

In certain embodiments, the user account information for a user may also include configuration data for one or more applications associated with the user. For example, the user account information for a user of device 110 may include information related to device 110, information related to application 114 and also information related to the configuration data for application 114. The configuration data may include information related to one or more configuration settings for application 114 including default settings and also user-configured or customized settings. In some embodiments, all the configuration data for application 114 may be stored as part of the user account information for a user of device 110. In another embodiment, so as to minimize the amount of configuration data stored, information related to only the user-configured configuration settings may be stored. In some embodiments, for a particular user, the configuration data may be stored on a per-application basis. In certain embodiments, application sharing system 104 can monitor and track changes to configuration settings for an application associated with a user account and the stored information to reflect the updated current configuration settings.

In some embodiments, user account information may be stored on a per-user-per-application basis. In such an embodiment, if a user is associated with multiple applications, then multiple user accounts, one for each application, may be stored in user account storage 102. The information for each user account may include information identifying the user, identifying the particular application, configuration data for the application, the user's purchase history related to the application, and other information.

In some embodiments, application sharing system 104 can provide access control services in cooperation with one or more data stores such as user account storage 102. Application sharing system 104 may also be configured to generate content such as text, graphics, audio, and/or video to be delivered to the user in the context of the application sharing facilities provided by application sharing system 104.

The application sharing facilities provided by application sharing system 104 can be explained using the following example user case scenario. A user of device 110 (“User_1” or “U1”) may purchase and download application 114 onto device 110. In one embodiment, application sharing system 104 may facilitate the purchase of application 113 by User_1 and the download of application 114 to device 110. Application 114 may be downloaded and installed with certain default configuration data including certain default configuration settings. At the time of purchase, if not already present, a user account (“U1 Account”) may be created by application sharing system 104 for User_1. In some embodiments, configuration data for application 114 may be stored as part of the user account information for User_1.

Once downloaded and installed on device 110, User_1 can use and interact with application 114 using device 110. The interactions may cause one or more of the configuration settings of application 114 to be changed or set. For example, User_1's interactions with application 114 may include the User_1 explicitly setting one or more configuration settings (i.e., assigning or setting particular values for one or more configuration settings) for application 114. This may include changing one or more default settings. For example, for a browser application, User_1 may change the default home page from www URL_1.com (default setting) to www.UserPreferredURL.com. As another example, User_1 may set the security preferences for the browser application, which may not be set as part of the default configuration data. Various other configuration settings may be configured by the user.

In some other embodiments, User_1's interactions with application 114 may cause one or more configuration settings for application 114 to be set automatically. For example, the configuration settings may be automatically set from the manner in which User_1 uses application 114. For example, User_1's interactions with application 114 may be tracked, and inferences drawn about the user's preferences. One or more configuration settings for application 114 may then be set based upon these inferences.

In certain embodiments, the configuration data, including changes to the configuration data, may be stored locally by device 114 and managed by application 114. In embodiments where changes to an application's configuration data are also stored and tracked by application sharing system 104, information may be conveyed from device 110 to application sharing system 104 regarding the changes. In one embodiment, application 114 may be configured to send a notification to application sharing system 104 indicative of the configuration settings changes. Application sharing system 104 may then update the configuration data stored for application 114 for User_1. In this manner, application sharing system 104 keeps track of users' downloading of applications and also of changes made to the configuration settings for the various applications.

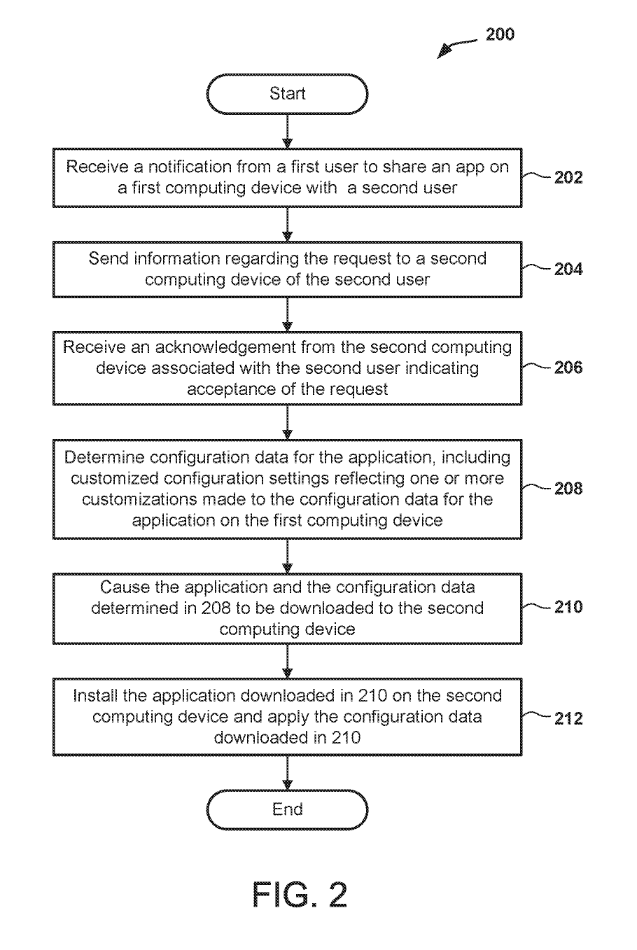

User_1 of device 110 can then refer application 114 to another user or indicate a desire to share application 114 with another user. For example, User_1 of device 110 may refer application 114 to User_2 of device 112. The sharing of application 114 with device 112 and the onboarding of User_2 for the application is then facilitated by application sharing system 104. FIG. 2 illustrates an example flowchart 200 illustrating processing performed by an application sharing system for sharing an application and associated configuration data in accordance with some embodiments of the present invention. The processing depicted in FIG. 2 may be implemented in software (e.g., code, instructions, program) executed by one or more processing units (e.g., processors, cores), hardware, or combinations thereof. The software may be stored in memory (e.g., on a non-transitory computer-readable storage medium such as a memory device). The particular series of processing steps depicted in FIG. 2 is not intended to be limiting. It is appreciated that the processing steps may be performed in an order different from that depicted in FIG. 2, and that not all the steps depicted in FIG. 2 need be performed. In one embodiment, the processing depicted in FIG. 2 is performed by application sharing system 104 and devices 110 and 112 depicted in FIG. 1.

At 202, application sharing system 104 receives a request from a first user indicative of a desire by the first user to share a particular application on a first computing device with a second user. For example, application sharing system 104 in FIG. 1 may receive a request 114 from device 110 of User_1 indicative of a desire by User_1 to refer or share application 114 on device 110 with User_2. In one embodiment, User_1 may perform an action on device 110 that causes the request (share or referral request) to be generated on device 110 and communicated to application sharing system 104.

For example, in one embodiment, if device 110 provides a touch-sensitive input interface such as a touch screen, User_1 may perform a particular gesture (e.g., a swipe gesture across the screen) relative to application 114 that causes the share request to be generated and communicated to application sharing system 104 from device 110. In one embodiment, the gesture may be performed when User_1 is within application 114. In another embodiment, the gesture may be performed by User_1 in a dashboard/homepage showing possibly multiple applications including application 114 (e.g., on a springboard on iOS devices that is used for launching applications loaded on a device). For example, the flick may be performed on an icon of application 114 and may be performed in the direction of a representation of User_2 (e.g., an image or contact information for User_2) on device 110 to identify the second user. In one embodiment, upon performing a special action (e.g., a flick) on an icon of the application to be shared on a home screen of the first user's device, a prompt may be displayed to the first user for identifying the recipient of the application to be shared. The first user may then respond to the prompt by entering information identifying the second user (e.g., a name of the second user, a phone number associated with the second user, an email address associated with the second user, etc.) and then selecting “send” to initiate the sharing request. In yet other alternative embodiments, various other ways may be used for generating the share request on device 110 and communicating the request to application sharing system 104.

The request received in 202 may include various pieces of information related to the request. In certain embodiments, the request may include, without restriction, information identifying the first user, information identifying the first computing device, information identifying the application being referred or to be shared, information identifying the second user, and possibly information identifying a device of the second user. In some embodiments, the request may also comprise configuration data for the application on the first computing device that includes at least one user-configured or user-customized configuration setting.

In certain embodiments, application sharing system 104 may perform certain checks (not shown in FIG. 2) to verify the request received in 202 before proceeding with processing to process the request. For example, in one embodiment, application sharing system 104 may first verify/authenticate the first user (e.g., User_1). As part of this verification, application sharing system 104 may check if the first user has an account that is stored and managed by application sharing system 104 for the application to be shared and only proceed with further processing when such an account has been verified.

At 204, information related to the sharing request received by the application sharing system may be sent to a second computing device associated with the second user. For example, as depicted in FIG. 1, information 116 regarding the request may be communicated from application sharing system 104 to device 112 of User_2. In certain embodiments, the information communicated to the second device may include information identifying the application, information identifying the first user who desires to share the application with the second user, and information indicating to the second user that the first user has indicated a desire to refer or share the application with the second user. For example, in FIG. 1, the information 116 sent to device 112 may include information identifying User_1 and information identifying application 114, and information indicating that User_1 wishes to refer or share application 114 with User_2. In some embodiments, the effects of accepting the request may also be conveyed to the second user. In certain embodiments, the information may be displayed as a prompt on the screen of the second computing device with selectable options for the second user to either accept or deny (not accept) the request.

At 206, the application sharing system may receive a notification from the second computing device whether the second user has accepted or denied the sharing request. In FIG. 2, it is assumed that an acknowledgement is received from the second computing device that the second user has accepted the sharing request. If, on the other hand, the second user denies or does not accept the request, then processing ends.

At 208, the application sharing system may determine the configuration data that is associated with the application on the first computing device and which is to be communicated to the second computing device. The configuration data determined in 208 includes one or more customized configuration settings reflecting one or more customizations made to the configuration data for the application on the first computing device as a result of the first user's interactions with the application on the first computing device. For example, in FIG. 1, application sharing system 104 may determine the configuration data for application 114 on device 110, the configuration data including at least one customized configuration setting reflecting at least one customization made to the configuration data for application 114 on device 110 as a result of User_1's interactions with application 114 on device 110.

In some embodiments, the entire configuration data associated with the application on the first computing device may be determined in 208. In another embodiment, a portion of the configuration data associated with the application on the first computing device may be determined in 208. The portion that is determined may include the customizations made by the first user to the application configuration data on the first computing device. Accordingly, in this another embodiment, not all the configuration data is determined but only portions of the configuration data including customized configuration settings.

As part of the processing in 208, if not already created, the application sharing system may also create an account for the second user for the application and associate the configuration data determined in 208 with the account information for the second user. In some embodiments, a new username and/or password can be generated for the second user. In certain embodiments, the application sharing system can auto-populate the second user's username based on other accounts with other applications that the second user has. The application sharing system can generate a temporary password and send the login information to the second user via a message (e.g., email message, text message, etc.). In some embodiments, additional information, if needed, to set up the account for the second user may be requested from the second user. For example, in FIG. 1, application sharing system 104 may create a new account for User_2 and associate the configuration data determined in 208 with the account for User_2. The account information for the first user may also be updated to indicate that the first user has referred or shared the application with the second user and that the second user has accepted the sharing. The accounts of the first user and the second user are however separate accounts and are not linked to each other.

In some embodiments, the application sharing system can store (e.g., in data store 102 in FIG. 1) configuration settings for application on the first computing device as part of the account information for the first user. Upon receiving the acknowledgement in 206, the application sharing system may retrieve the configuration settings for the particular application from the first user's account information from data store 102. The application sharing system may generate a copy of these configuration settings and store and associate the copy with the account created for the second user.

At 210, the application sharing system may cause the application and the configuration data determined in 208 to be communicated to the second computing device. For example, the application sharing system may push the application and the configuration data to the second computing device. For example, in FIG. 1, application sharing system 104 may cause application and configuration data 120 to be communicated to device 112. In one embodiment, upon determining the configuration data associated with the application on the first computing device in 208, the application sharing system may make a copy of the configuration data and communicate the copy to the second computing device in 210. In some embodiments, installation instructions for the second computing device on how the application is to be installed may also be communicated to the second computing device in 210.

Various different communication channels may be used for downloading the application and its associated configuration data to the second computing device. In certain embodiments, the communication may occur via a communication network (e.g., network 106 depicted in FIG. 1) such as the Internet. Wired or wireless communication links may be used for the communications.

At 212, the application downloaded in 210 is installed on the second computing device and the configuration data downloaded in 210 is applied to the application. Since the configuration data includes customizations made to the configuration settings for the application on the first user's first computing device, the first user's customizations are now reflected in the application installed on the second computing device. The second user can then start using the application installed on the second computing device with the configuration settings customizations made by the first user to the application on the first computing device.

In some embodiments, the operating system on the second computing device may facilitate the installation in 212. In certain embodiments, when an operating system on the second computing device detects the successful installation of the application, it may retrieve the configuration data from the application sharing system 104 using the first user's ID, the second user's ID, and/or the application's ID. The operating system may then deploy the configuration data on the second computing device. In certain embodiments, when the application is downloaded to the second computing device, the application store can attach a “referral ID”, which indicates that the download is caused by a sharing event. After successful installation and initial launch, the application can determine the referral ID from the operating system and the configuration data may be retrieved from the sharing system using the referral ID.

After an application has been downloaded with the customized configuration data to the second computing device, the users of the first device and the second device can interact with the applications installed on their respective devices independent of each other. The first user can make further changes to the configuration data for the application installed on the first user's device (e.g. configuration data changes for application 114 on device 110) without affecting or impacting the application or its configuration data on the second user's device. Similarly, the second user can make changes to the configuration data for the application installed on the second user's device without affecting or impacting the application or its configuration data on the first user's computing device.

Although the example depicted in FIG. 2 and described above shows sharing between a first user and a second user, this is not intended to be restrictive. In alternative embodiments, a first user can share an application installed on the first user's device and its associated customized configuration data with multiple other users. A particular user can also download multiple applications and associated configuration data shared by multiple users. The application sharing system can keep track of the various users, and for each user, track the applications downloaded by the user as a result of sharing and the configuration data downloaded for each of the shared applications.

In the embodiment depicted in FIG. 2 and described above, both the application and the configuration data are downloaded in 210. This is however not meant to be restrictive. The order in which the application and its configuration data are downloaded may vary in different embodiments. For example, in one embodiment, the application may be downloaded and installed on the second computing device and the configuration data may subsequently be downloaded and applied to the installed application. In some other embodiments, the configuration data may be downloaded before the application is downloaded.

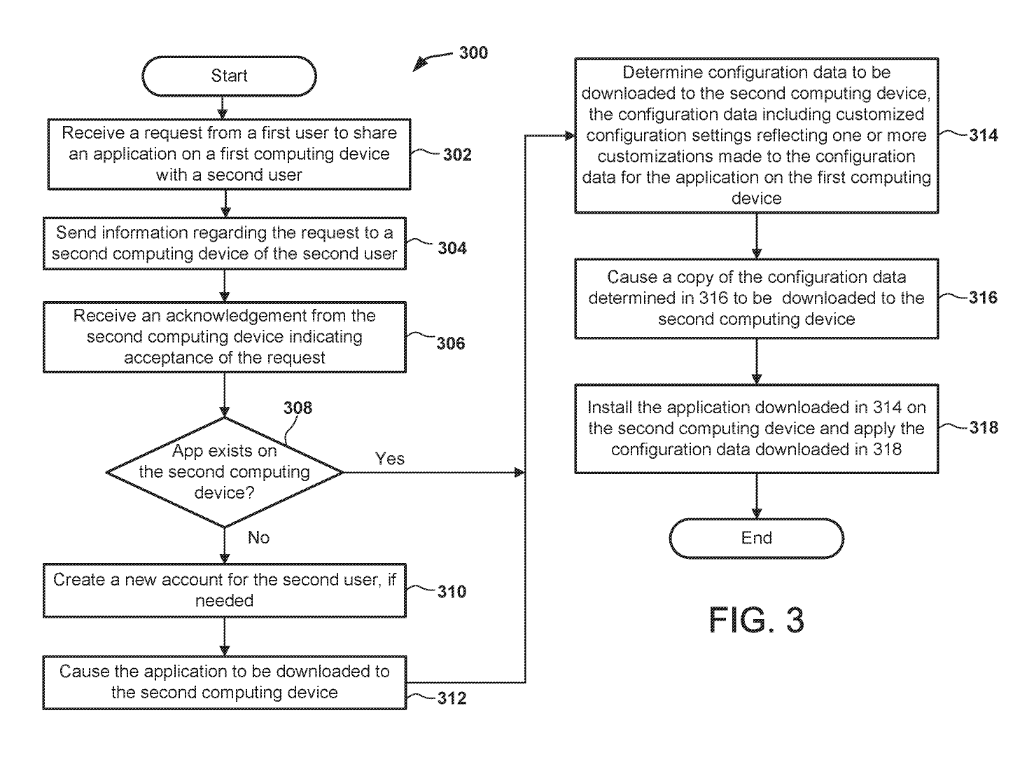

FIG. 3 illustrates another example flowchart 300 illustrating processing performed for sharing an application and its associated configuration data including one or more customized configuration settings in accordance with some embodiments of the present invention. The processing depicted in FIG. 3 may be implemented in software (e.g., code, instructions, program) executed by one or more processing units (e.g., processors, cores), hardware, or combinations thereof. The software may be stored in memory (e.g., on a non-transitory computer-readable storage medium such as a memory device). The particular series of processing steps depicted in FIG. 3 is not intended to be limiting. It is appreciated that the processing steps may be performed in an order different from that depicted in FIG. 3, and that not all the steps depicted in FIG. 3 need be performed. In one embodiment, the processing depicted in FIG. 3 is performed by application sharing system 104 and devices 110 and 112 depicted in FIG. 1.

At 302, an application sharing system (e.g., application sharing system 104 in FIG. 1) may receive a request from a first user (e.g., User_1 in FIG. 1) indicative of a desire by the first user to share a particular application (e.g., application 114) on a first computing device (e.g., device 110) with a second user (e.g., User_2 in FIG. 1). The request received in 302 may include information such as information identifying the first user, information identifying the first computing device, information identifying the application being referred or to be shared, information identifying the second user, and possibly information identifying a device of the second user. In some embodiments, the request may also comprise configuration data for the application on the first computing device that includes at least one user-configured or user-customized configuration setting. As described above with respect to FIG. 1, in certain embodiments, the first user may perform an action on the first computing device that causes the request (share or referral request) to be generated on the first computing device and communicated to application sharing system 104.

At 304, information related to the sharing request received by the application sharing system may be sent to a second computing device associated with the second user. For example, as depicted in FIG. 1, information 116 regarding the request may be communicated from application sharing system 104 to device 112 of User_2. In certain embodiments, the information communicated to the second device may include information identifying the application, information identifying the first user who desires to share the application with the second user, and information indicating to the second user that the first user has indicated a desire to refer or share the application with the second user. For example, in FIG. 1, the information 116 sent to device 112 may include information identifying User_1 and information identifying application 114, and information indicating that User_1 wishes to refer or share application 114 with User_2. In some embodiments, the effects of accepting the request may also be conveyed to the second user. In certain embodiments, the information may be displayed as a prompt on the screen of the second computing device with selectable options for the second user to either accept or deny (not accept) the request.

At 306, the application sharing system may receive a notification from the second computing device whether the second user has accepted or denied the sharing request. In FIG. 3, it is assumed that an acknowledgement is received from the second computing device that the second user has accepted the sharing request. If, on the other hand, the second user denies or does not accept the request, then processing ends. In certain embodiments, the second user may select acceptance or denial by performing a finger tap on the appropriate user-selectable options displayed to the second user.

At 308, the application sharing system determines whether the application to be shared (e.g., application 114 in FIG. 1) already exists on the second computing device. If it is determined in 308 that the application exists on the second computing device, then processing continues with 316 and in the event it is determined that the application does not exist on the second computing device, then processing continues with 310.

At 310, the application sharing system creates a new account for the second user, if one does not already exist. As part of creating the new account, the application sharing system may create a new login username for the second user and a temporary password for the account. The username and temporary password may be communicated to the second user such as via an email message, a text message, and the like.

At 312, the application sharing system causes the application to be shared to be downloaded to the second computing device used by the second user. For example, in FIG. 1, application sharing system 104 may cause application 114 to be communicated to device 112.

At 314, the application sharing system determines configuration data to be downloaded to the second computing device, the configuration data including customized configuration settings reflecting one or more customizations made to the configuration data for the application on the first computing device. For example, in FIG. 1, application sharing system 104 may determine the configuration data for application 114 on device 110, the configuration data including at least one customized configuration setting reflecting at least one customization made to the configuration data for application 114 on device 110 as a result of User_1's interactions with application 114 on device 110.

In certain embodiments, the configuration data determined in 314 may be limited based upon a time parameter. For example, in one embodiment, only that configuration data customized by the first user within a predetermined time period is determined. The predetermined time period may be measured relative to when the application sharing system receives the request in 302. For example, only configuration data customizations made to the configuration data on the first computing device within a predetermined time since the receipt of the request in 302 may be determined in 316. The pre-determined time period may be the past 24 hours, past 12 hours, and so on. In some other embodiments, the pre-determined time period may be measures relative to when the application was installed on the first computing device.

In some examples, the configuration data determined in 314 can include all of the configuration data changes of the application done by the first user within the predetermined time period. In some examples, the configuration data determined at 316 can include some, but not all, of the configuration data changes of application done by the first user during the predetermined time period. For example, in one embodiment, the configuration data may include configuration data changes made for the look and feel of application configured by the first user, and not include configuration data changes that control other behaviors of the application.

In certain embodiments, the first user may be enabled to identify what configuration data are sharable with other users. For example, in FIG. 1, User_1 may identify what configuration data changes for application 114 are sharable with User_2. In some embodiments, the configuration data that are sharable can be identified by the first user on a per-second user basis.

At 316, the application sharing system may cause a copy of the configuration data determined in 316 to be downloaded to the second computing device. As part of 318, the copy of the configuration data for the application may also be stored in the second user's account.

At 318, the application downloaded in 314 is installed on the second computing device and the configuration data downloaded in 318 applied to the application. Since the configuration data downloaded in 318 includes customizations made to the configuration settings for the application on the first user's first computing device, the first user's customizations are reflected now reflected in the application installed on the second computing device. The second user can then start using the application installed on the second computing device with the configuration settings customizations made by the first user to the application on the first computing device.

After the application has been downloaded with the customized configuration data to the second computing device, the users of the first device and the second device can interact with the applications installed on their respective devices independent of each other. The first user can make further changes to the configuration data for the application installed on the first user's device (e.g. configuration data changes for application 114 on device 110) without affecting or impacting the application or its configuration data on the second user's device. Similarly, the second user can make changes to the configuration data for the application installed on the second user's device without affecting or impacting the application or its configuration data on the first user's computing device.

Accordingly, after the download, the application on the first computing device and its associated configuration data and the application on the second computing device and its associated configuration data may have their own independent life cycles. In some alternative embodiments, the configuration data for application for the first user and the second user can be synchronized so that the first and second users can have the same configuration for their respective applications for a predetermined time period after the application has been downloaded and installed on the second computing device.

Further, the second user may configure the application on the second computing device and generate customized configuration data for the application 114 and share the application and the customized configuration data made by the second user with one or more other users of the second user's choice.

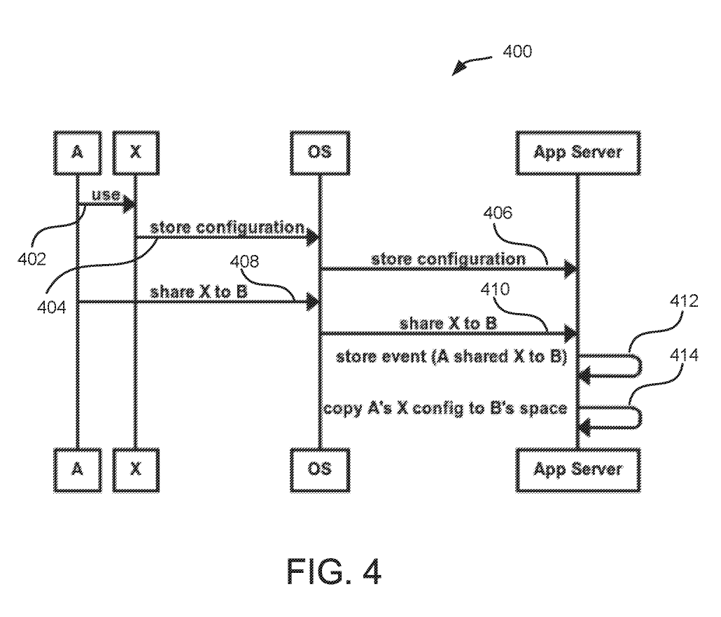

FIG. 4 is a sequence chart illustrative of a process 400 for sharing an application in accordance with certain embodiments. As shown in FIG. 4, at 402, a user A (“A” in FIG. 4) may interact with an application X (“X” in FIG. 4) on a computing device associated with the user (e.g., such as computing device 110 associated with User_1 in FIG. 1). As a result of the interactions, the configuration data for application X may be changed user A's computing device. The configuration data for application X, including customization to one or more configuration settings in the configuration data may be stored locally on user A's device on which application X is installed and used by user A.

At 404, a request may be generated to store the configuration data for application X on an application server (e.g., on application sharing system 104 depicted in FIG. 1). In one embodiment, as depicted in FIG. 4, the request may be generated by application X and communicate to the operating system on user A's device. At 406, the operating system may communicate the request and the configuration data for application X that is to be stored to the application server. As part of 406, the application server may store the configuration data for application X received from user A's device. In one embodiment, application server may store the configuration data as part of user account information for user A.

In certain embodiments, application X may be configured to generate the store requests on a periodic basis such that the most current configuration data, including any changes or customizations to one or more configuration settings made by user A, are stored in a data store accessible to the application server.

At 408, user A may initiate a request to share application X and its associated configuration data with another user B. In certain embodiments, the request to share may be generated via application X or via the operating system of user A's device. In the embodiment depicted in FIG. 4, the request is received by operating system on user A's device.

At 410, the request to share application X with B is transmitted to the application server. At 412, the request may be stored by the application server. In one embodiment, the request may be stored as part of user A's account information.

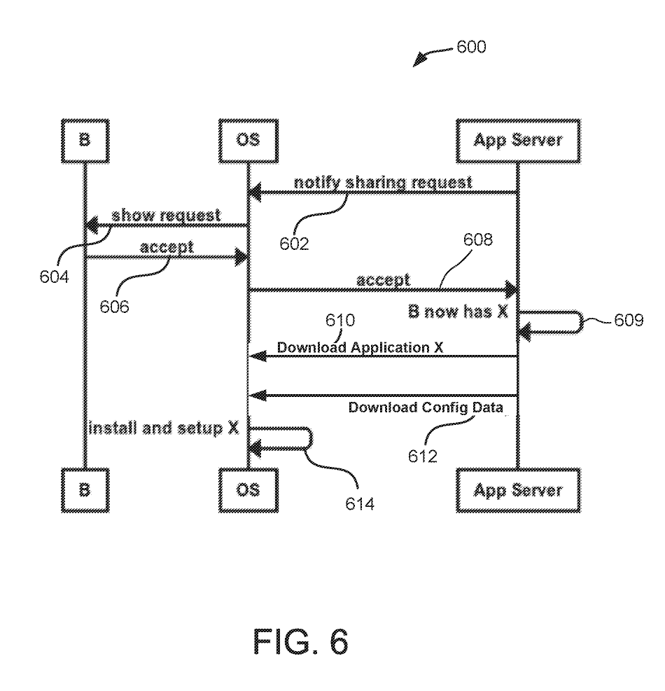

At 414, a copy of user A's configuration data (which may be stored by the application server as part of user A's account information) is copied to user B's user account. Further processing is depicted in FIG. 6 and described below.

In some embodiments, all or a majority of the configuration data for an application may be stored locally on the device on which the application is installed. Some applications may be configured to store their configuration data or portions thereof in the cloud for the user of the application or on one or more remote servers. Some applications may use a combined approach, where part of the configuration data is stored locally and some configuration data is stored in the cloud. In embodiments, where the configuration data (or a portion thereof) for an application is stored in the cloud, the application sharing system may be configured to access this configuration data from the cloud provider.

In certain embodiments, where the configuration data (or a portion thereof) for an application is stored in the cloud, after the application has been shared with the second user (or the recipient of the application), a cloud account may need to be created for the recipient. In other embodiments, the configuration data may be stored locally for the second user on the second user's device. In yet other embodiments, a cloud account for the second user may be created by cloning the cloud account for the first user (with different levels of protection on what can be cloned and what cannot be cloned) with a different user name, password, and/or account.

As previously described, the first user (i.e., the user wanting to share) may perform an action on the first user's device that results in the generation of an application share request and the communication of that request from the first user's device to an application sharing system. In certain embodiments, the ability to recognize when a sharing request is to be generated may be built into the application itself. For example, the developer of the application may implement various trigger within the application when a sharing request is to be generated. For example, a sharing request may be generated when the application receives a signal that the user of the device has performed a specific action (e.g., a flick-to-send function which comprises a long press and flick). In certain embodiments, the application may be configured to recognize this triggering event when the specific action is performed anywhere within the application. In some alternative embodiments, the application may be configured to recognize this triggering event when the specific action is performed within a specific region or portion within the application (e.g., within a specific area of a particular GUI (graphical user interface) of the launched application). In some embodiments, the user input can be directed at an application icon on the home screen of the sharing user's device (e.g., on the springboard on an iOS device such as an iPad® or iPhone®). Upon detecting a desire to share an application, the mobile device may then allow the sharing user may to specify a recipient (e.g., by selecting a recipient through an address book, by specifying a phone number or a handle, etc.).

In one use case scenario, a first user may have found a nice weather application. The first user installs the application on the first user's device and customizes the application by adding a number of cities of interest to the first user. The first user may at some later time point desire to refer the application to a second user such as the first user's wife so that the second user can also have the application on the second user's device (e.g., phone). Typically, this would require the second user to have to perform the following activities: find the same weather application, install the application on the second user's device, and then add all of the same cities as the first user. For a second user who is not technically savvy, these activities may be beyond the second user's capabilities. Even for a technically savvy second user, it may take time to perform the activities. The teachings described in this disclosure enable the second user to get the specific application along with the cities added by the first user by simply accepting the share request from the first user. As described herein, the weather application is automatically downloaded and installed on the second user's device and the first user's customizations (e.g., the cities added by the first user) applied to the installed, without requiring any further inputs from the second user. After the install, the second user not only has the same weather application but also has the customizations (e.g., cities added by the first user) to the application made by the first user. The second user can then interact with the application installed on the second user's device independent of the application or the associated configuration data on the first user's device.

Some embodiments may enable the sharing of cloud data in addition to setting configurations. In some embodiments, the original application may be associated with a cloud account. When the user flicks/shares the application, the account gets copied and the share recipient gets all the data as-is. Since the share recipient is a new user, a separate account from the original user is set up for the recipient with its own login information (e.g., username and temporary password). The share recipient may then perform any additional changes to the application to his or her own liking. Application developers may make this functionality that shares an application, account data, and/or setting configuration available for some applications but not all applications. Application developers may also transfer certain types of data and configuration settings in light of privacy issues and application semantic issues.

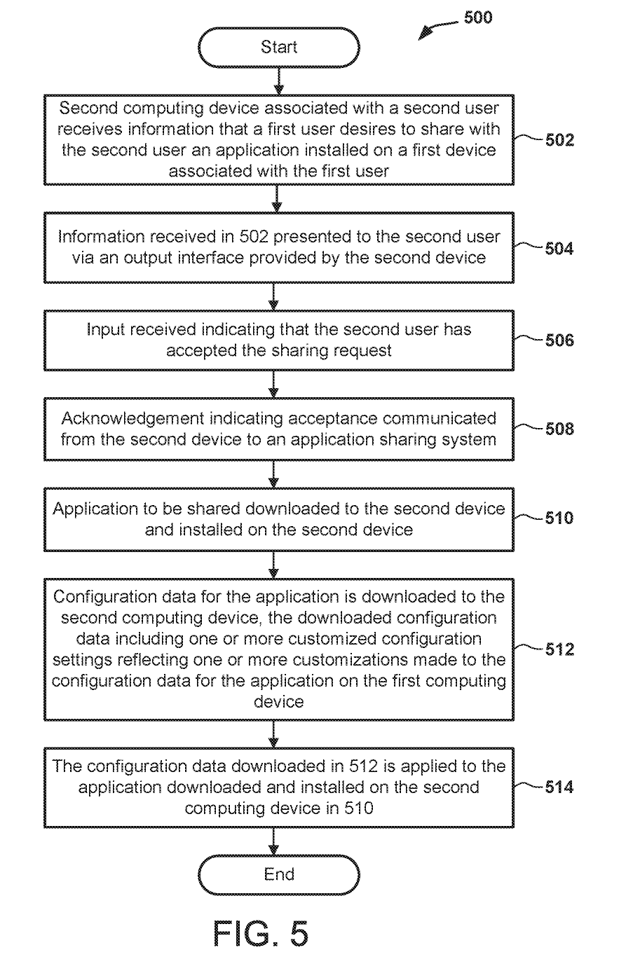

FIG. 5 illustrates an example flowchart 500 for processing performed for sharing an application from the perspective of a device of the user receiving the application (i.e., the recipient of the application sharing) in accordance with certain embodiments of the present invention. The processing depicted in FIG. 5 may be implemented in software (e.g., code, instructions, program) executed by one or more processing units (e.g., processors, cores), hardware, or combinations thereof. The software may be stored in memory (e.g., on a non-transitory computer-readable storage medium such as a memory device). The particular series of processing steps depicted in FIG. 5 is not intended to be limiting. It is appreciated that the processing steps may be performed in an order different from that depicted in FIG. 5, and that not all the steps depicted in FIG. 5 need be performed. For example, in one embodiment, the processing depicted in FIG. 5 and described below may be performed by device 112 depicted in FIG. 1. For the description below related to FIG. 5, the user receiving the shared application is referred to as the second user and the device of the second user is referred to as the second device. The user desiring to share an application is referred to as the first user and the device of the first user is referred to as the first device.

At 502, a second computing device associated with a second user receives information that a first user desires to share with the second user an application installed on a first device associated with the first user. The second device may receive the request in 502 from an application sharing system 104.

At 504, the information received in 502 is output to the second user via an output interface provided by the second device. For example, the information may be output via a display of the second device. As part of the display, user-selectable options may be displayed enabling the second user to accept of refuse/deny the sharing request.

At 506, the second device may receive the second user's input indicating that the second user has accepted the sharing request. If the input received in 506 indicates that the second user has refused to accept the request, then processing ends.

At 508, an acknowledgement notification is communicated from the second device to the application sharing system indicating that the second user has accepted the sharing request.

At 510, the application to be shared is downloaded to the second device and installed on the second device. The second device may receive the application from the application sharing system. In some embodiments, instructions for how to install the application may also be received.

At 512, configuration data for the application downloaded in 510 is downloaded to the second computing device. The configuration data downloaded in 512 includes one or more customized configuration settings reflecting one or more customizations made to the configuration data for the application on the first computing device by the first user.

At 514, the configuration data received in 512 is applied to the application downloaded and installed in 510. The second user is now free to use the installed application.

FIG. 6 is a sequence chart illustrative of a process 600 for accepting an application sharing request originated by a first user (e.g., User A) at second user's (e.g., User B) device in accordance with certain embodiments. In this example, it is assumed that an application server (“App Server” in FIG. 6)(or an application sharing system) has already received a sharing request from the device of a first user for sharing an application “X” with user B (indicated by “B” in the figure). At 602, the application server sends a notification to user B's device indicative of the sharing request. In one embodiment, as depicted in FIG. 6, the notification may be received by the operating system (“OS” in FIG. 6) on User B's device. At 604, the operating system in user B's device may cause information related to the request to output to User B, for example, via an output device (e.g., a screen) of User B's device.

At 606, user B may accept the sharing request. At 608, the operating system on User B's device may send a notification to the application server indicative of the acceptance. At 609, the application server may perform processing to enable the application to be shared with User B. For example, an account may be created for User B, if not already present. Configuration data from User A's device may be associated with the account information. As part of 609, a notification may also be sent to User B's device that application X and its associated configuration data (which is the configuration data from User A's device) is ready for download by User B's device.

At 610, the operating system on User B's device may download the application X from the application and, also at 612, download the configuration data associated with application X, where the configuration data is actually the configuration data from User A's device for application X. At 614, application X is installed and setup on User B's device. The configuration data downloaded in 612 may be applied to application X as part of the install and setup in 614. Application X can now be used by User B using User B's device.

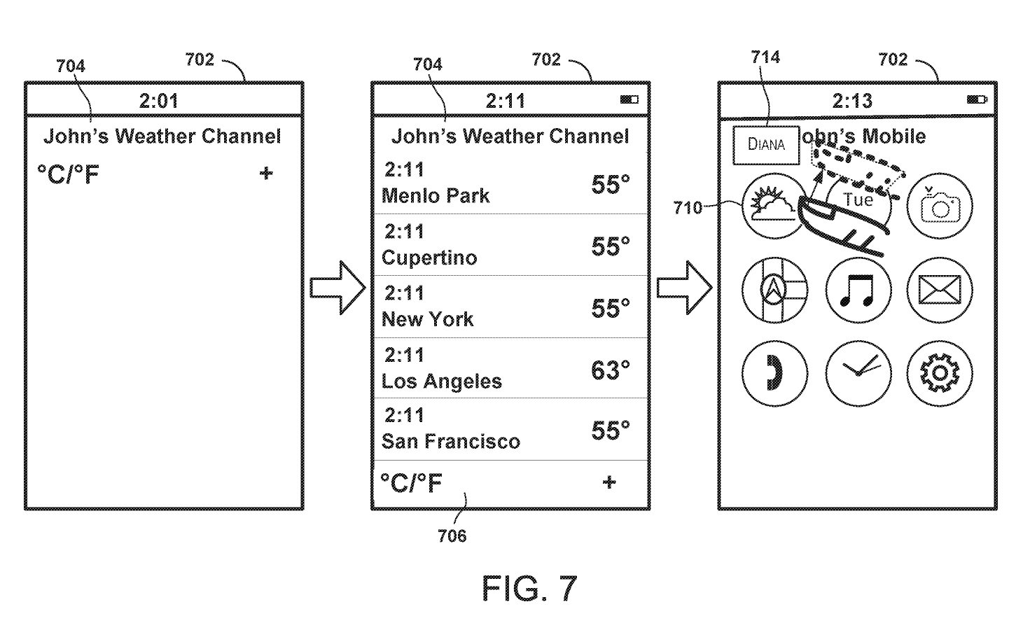

FIG. 7 illustrates an example of how a first user of a first device may refer or share an application on the first device and its associated customized configuration data with a second user in accordance with certain embodiments of the present invention. In this example, a computing device 702 may be used by a first user John. As shown, a weather application 704 has been installed on computing device 702. As shown on screen 706 of application 704, user John has configured weather application 704 with a set of cities (Menlo Park, Cupertino, N.Y., Los Angeles, and San Francisco) of interest to John. John has done this by customizing the configuration data for weather channel application 704 and adding the particular city names. John has also customized weather application 704 by selecting Fahrenheit as the unit for displaying the temperature. This customization is also done by making changes to the configuration data for application 704. In certain embodiments, application 704 may provide user interfaces that enable John to make these customizations.

John may wish to refer the weather application to another user Diana, an elderly women living in a nursing home. John may be aware that Diana is interested in the same cities as John and would also prefer to see the temperatures in Fahrenheit. Additionally, John may know that Diana is not technically savvy and would be unable to make the configuration changes on her own. As a result, John may decide to us the application sharing services described above to share the weather application 704 with Diana.

As shown, in FIG. 7, John may navigate to a dashboard 708 (e.g., springboard on iOS devices) on John's device 702. Dashboard 708 displays an icon 710 corresponding to weather application 704. John may then perform a finger gesture (e.g., a flick on icon 710) on icon 710 to indicate that application 704 is to be shared. In the example in FIG. 7, the flick may cause a dialog box 714 to be displayed in which John can type the name of the person with whom he wants to share the application. John can type in Diana's name and then hit the return key. This causes a share request to be communicated from John's device 702 to application sharing system 104.

There are various different ways in which John can indicate his desire to share an application and the person with whom the application is to be shared. In one example, Diana can be on a contact list of John. Performing the finger gesture may cause John's contact list to be displayed. John can then select one or more people with to whom John would like to refer the weather application.

In the above example, it is to be noted that Diana may or may not be related to John. Diana does not have to be within John's circle of friends. John does not have to somehow attach Diana or associate Diana with his own user account to enable the referring or sharing.

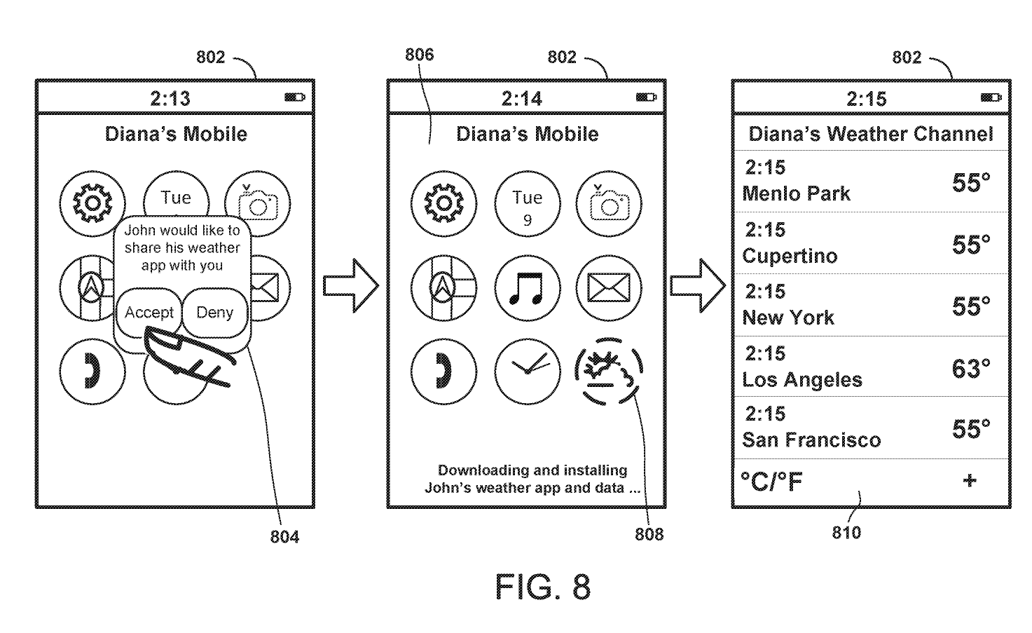

FIG. 8 illustrates an example of processing performed from the perspective of a user receiving an application and its associated configuration data as a result of a sharing request generated by another user in accordance with certain embodiments of the present invention. Carrying forward the example depicted in FIG. 7 and described above, the embodiment depicted in FIG. 8 is from Diana's perspective and the information displayed on her device 802. As can be seen in FIG. 8, a dialog box or notification 804 may be displayed on Diana's mobile device 802 indicating that user John would like to share the weather application with Diana. Diana may then either accept or deny the sharing request by choosing the appropriate button from the dialog box. If Diana accepts the request, then the weather application along with John's customized configuration data for the application is automatically downloaded to Diana's device 802. As can be seen from dashboard 806 on Diane's device 802, a new icon 808 is shown indicating that the weather application has been downloaded and installed on device 802. Further, a screenshot 810 from within the weather application in Diane's device 802 shows that the application has been automatically configured with the same cities as John's application (i.e., Menlo Park, Cupertino, N.Y., Los Angeles, and San Francisco) and Fahrenheit has been set as the unit for displaying the temperatures. The configuration data on Diane's device 802 for the weather application has been set to the same configuration settings as John's without Diane having to do anything with respect to the configuration data.

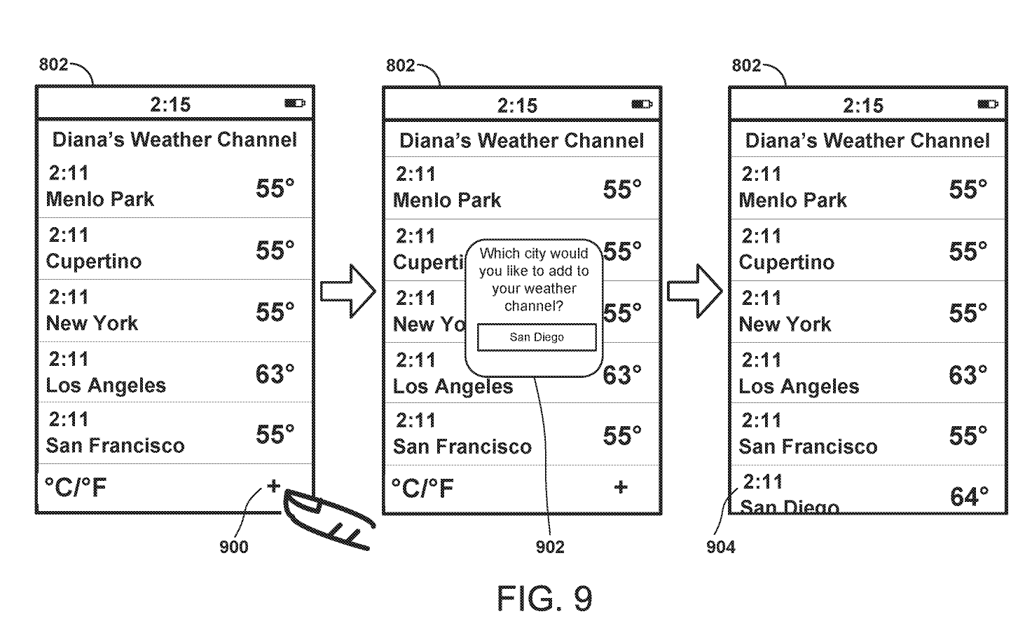

After an application has been downloaded with the customized configuration data to the second device (e.g., to Diane's device), the users of the first device and the second device can interact with the applications installed on their devices independent of each other. For example, in the above example, John can make further changes to the configuration data for the weather application installed on his device (e.g., adding or deleting a city for which the application shows the temperature) without affecting the weather application or its configuration data on Diane's device. Similarly, Diane can make changes (e.g., adding or deleting a city for which the application shows the temperature) to the configuration data for the weather application installed on her device without affecting the weather application or its configuration data on John's device. This is illustrated in the example depicted in FIG. 9. The embodiment in FIG. 9 shows interfaces on Diane's device. As shown in FIG. 9, Diane may decide to configure the weather application on her device to show temperature data for an additional city. Diane may do this by selecting (e.g., by tapping) “+” option displayed by the weather application on her device 802. A dialog box 902 may be displayed on Diane's device upon selecting “+” 900. Diane may then enter the name of the city to be added in dialog box 902, which changes the configuration data for the weather application on her device 802. As shown in FIG. 9, she enters “San Diego.” An entry 904 showing San Diego's temperature is then displayed in her weather application. Diane's changes do not affect John's weather application or its related configuration data. In other words, San Diego is not added to the weather application installed on John's device.

In the examples depicted in FIGS. 7, 8, and 9, and described above, the first and second devices of the first user (the referring user, e.g., John) and the second user (the target of the referral, e.g., Diane) respectively had screen output devices for displaying information related to the sharing request and the application being shared. In alternative embodiments, other types of user input and output interfaces may be provided. For example, the first device and/or the second devices may be devices in an IoT environment. Such devices may not have touch screens to serve as input and output devices but instead may provide other input and output mechanisms.

In certain embodiments, IoT devices may provide one or more lights for outputting information and one or more buttons for inputting information. For example, a first IoT device may provide a set of buttons as the input interface. A user of the first IoT device may use one or more of the buttons to select an application on the first IoT device to be shared with a second user. Once an application is selected, the user of the first IoT device may press another button provided on the first IoT device to indicate that the user desires to share the selected application with a second user.

In some embodiments, the second IoT device of the second user may provide a set of lights for outputting information and a set of buttons for inputting information to the IoT device. For example, in one embodiment, a dedicated light may be provided on the second IoT device, which when lit, indicates that a request has been received from a first user for sharing an application with the second device. A user of the second IoT device may then accept the request by pressing a button provided by the second IoT device. The application and the configuration data from the first IoT device may then downloaded to the second IoT device using the same teachings as described above.

In some embodiments, instead of a dedicated light, the color of a light on the second IoT device may indicate when a sharing request has been received by the second IoT device. For example, if a light is lit yellow (or some other particular color), it may indicate that the second IoT device has received a sharing request. In yet other embodiments, a light on the second IoT device may start blinking at a certain frequency to indicate that a sharing request has been received by the second IoT device.

In the manner described above, various different ways may be provided on devices for users of the devices to select an application to be shared, to generate sharing requests, and also for outputting information to users of the devices that sharing requests have been received by the devices and for the user to accept (or deny) the sharing requests. The examples described in this disclosure are thus not meant to be restrictive.

FIG. 10 is a simplified block diagram of a computer system 1000 that may be used in accordance with certain embodiments of the present invention. Computer system 1000 may be used to implement one or more of the client devices described above, such as devices 110 and 112 depicted in FIG. 1, device 702 depicted in FIG. 7, and device 802 depicted in FIGS. 8 and 9. Computer system 1000 may also be used to implement an application sharing system such as application sharing system 104 depicted in FIG. 1. Computer system 1000 can be of various types such as, without limitation, a mobile device, a handheld device, a notebook computer, a desktop computer, an IoT device, or any suitable electronic device. Further, while computer system 1000 is described with reference to particular blocks, it is to be understood that these blocks are defined for convenience of description and are not intended to imply a particular physical arrangement of component parts. Embodiments of the present invention can be realized in a variety of apparatus including electronic devices implemented using any combination of circuitry and software. Due to the ever-changing nature of computers and networks, the description of computer system 1000 depicted in FIG. 10 is intended only as a specific example for illustrative purposes. Many other configurations having more or fewer components than the system depicted in FIG. 10 are possible.

As depicted in FIG. 10, computer system 1000 includes a number of subsystems including a processing subsystem 1002, a storage subsystem 1004, a user input subsystem 1006, a user output subsystem 1008, and a network interface subsystem 1010. In the embodiment depicted in FIG. 10, the various subsystems are communicatively coupled to each other via a bus subsystem 1012. Bus subsystem 1012 provides a mechanism for letting the various components and subsystems of computer system 1000 communicate with each other as intended. Although bus subsystem 1012 is shown schematically as a single bus, alternative embodiments of the bus subsystem may utilize multiple busses.

Processing subsystem 1002, which can be implemented as one or more integrated circuits (e.g., one or more single-core or multi-core microprocessors or microcontrollers), can control the operation of computer system 1000. Processing subsystem 1002 may include without limitation one or more general-purpose processors and/or one or more special-purpose processors (such as digital signal processing chips, graphics acceleration processors, sensory chips, and/or the like). The processors may include one or more multicore processors. In various embodiments, processing subsystem 1002 can execute a variety of programs (e.g., program code, instructions) that cause various functions to be performed and can maintain multiple concurrently executing programs or processes. At any given time, some or all of the program code to be executed can be resident in processing subsystem 1002 and/or in storage subsystem 1004.

Through suitable programming, processing subsystem 1002 can provide various functionalities for computer system 1000. For example, processing subsystem 1002 can execute one or more applications 1016 installed on computer system 1000. Application 1016 can perform various methods for various functionalities of an application.

Storage subsystem 1004 provides a non-transitory medium for storing information and code (instructions) that can be executed by one or more processing units (e.g., processors) of processing subsystem 1002. For example, storage subsystem 1004 may be configured to store the basic programming (e.g., application 1016) and data constructs that provide the functionality of certain embodiments of the present invention. Storage subsystem 1004 may also provide a repository for storing data used in accordance with the present invention. For example, configuration data associated with an application may be stored by storage subsystem 1004. Programs and/or data can be stored in non-volatile storage and copied in whole or in part to volatile working memory during program execution. Storage subsystem 1004 can be implemented, e.g., using disk, flash memory, or any other storage media in any combination, and can include volatile and/or non-volatile storage as desired.

In certain embodiments, storage subsystem 1004 may comprise a memory subsystem and a file/disk storage subsystem. The memory subsystem may include a number of memories such as a main random access memory (RAM) for storage of instructions and data during program execution, a read only memory (ROM) in which fixed instructions are stored, flash memory, and the like. In certain embodiments, various software elements may be located within system memory such as an operating system, device drivers, executable libraries, and/or other code, such as one or more application programs 1016. The file storage subsystem may provide persistent (non-volatile) storage for program and data files, and may include a hard disk drive, a floppy disk drive along with associated removable media, a Compact Disk Read Only Memory (CD-ROM) drive, an optical drive, removable media cartridges, local and/or network accessible storage, and other like storage media.

User input devices 1006 may include one or more different mechanisms for providing inputs to computer system 1000 such as, without limitation, a mouse, a keyboard, a touchpad, a tablet, user-selectable buttons, and/or the like. User input devices 1006 can include a touch pad, touch screen, scroll wheel, click wheel, dial, button, switch, keypad, microphone, or the like.

User output devices 1008 can include one or more different mechanisms for outputting information from computer system 1000, such as, without limitation, a display screen, indicator lights, speakers, headphone jacks, or the like, together with supporting electronics (e.g., digital-to-analog or analog-to-digital converters, signal processors, or the like).

Computer system 1000 may include a network interface subsystem 1010 that enables and facilitates data communications to and from computer system 1000. Network interface subsystem 1010 can include without limitation a modem, a network card (wireless or wired), an infrared communication device, a wireless communication device and/or chipset (such as a Bluetooth® device, an 802.11 device, a WiFi device, a WiMax device, cellular communication facilities, etc.), and/or the like. Network interface subsystem 1010 may permit data to be exchanged with a network, other computer systems, and/or any other devices described herein. For example, if system 1000 is used to implement an application sharing system, network interface subsystem 1010 may facilitate communications with one or more client devices. In some embodiments network interface 1010 can provide wired network connectivity (e.g., Ethernet). Network interface 1010 can be implemented using a combination of hardware (e.g., antennas, modulators/demodulators, encoders/decoders, and other analog and/or digital signal processing circuits) and software components.

The terms “machine-readable medium” and “computer-readable medium,” as used herein, refer to any non-transitory medium that participates in providing data that causes a computer system to operate in a specific fashion. In an embodiment implemented using the computer system 1000, various computer-readable media might be involved in providing instructions/code to processor(s) 1002 for execution and/or might be used to store such instructions/code. Computer-readable medium may take many forms such as non-volatile media and volatile media.

The methods, systems, and devices discussed above are examples. Various embodiments may omit, substitute, or add various procedures or components as appropriate. For instance, in alternative configurations, the methods described may be performed in an order different from that described, and/or various stages may be added, omitted, and/or combined. Features described with respect to certain embodiments may be combined in various other embodiments. Different aspects and elements of the embodiments may be combined in a similar manner. Technology evolves and, thus, many of the elements are examples that do not limit the scope of the disclosure to those specific examples.

Specific details are given in the description to provide a thorough understanding of the embodiments. However, embodiments may be practiced without these specific details. For example, well-known circuits, processes, algorithms, structures, and techniques have been shown without unnecessary detail in order to avoid obscuring the embodiments. This description provides example embodiments only, and is not intended to limit the scope, applicability, or configuration of the invention. Rather, the preceding description of the embodiments will provide those skilled in the art with an enabling description for implementing embodiments of the invention. Various changes may be made in the function and arrangement of elements without departing from the spirit and scope of the invention.

Although specific embodiments of the invention have been described, various modifications, alterations, alternative constructions, and equivalents are also encompassed within the scope of the invention. Embodiments of the present invention are not restricted to operation within certain specific data processing environments, but are free to operate within a plurality of data processing environments. Additionally, although certain embodiments have been described using a particular series of transactions and steps, it should be apparent to those skilled in the art that the scope of the present invention is not limited to the described series of transactions and steps. Although some flowcharts describe operations as a sequential process, many of the operations can be performed in parallel or concurrently. In addition, the order of the operations may be rearranged. A process may have additional steps not included in the figure.

Further, while certain embodiments have been described using a particular combination of hardware and software, it should be recognized that other combinations of hardware and software are also within the scope of the present invention. Certain embodiments of the present invention may be implemented only in hardware, or only in software (e.g., code programs, firmware, middleware, microcode, etc.), or using combinations thereof. The various processes described herein can be implemented on the same processor or different processors in any combination. Accordingly, where components or modules are described as being configured to perform certain operations, such configuration can be accomplished, e.g., by designing electronic circuits to perform the operation, by programming programmable electronic circuits (such as microprocessors) to perform the operation such as by executing computer instructions or code, or any combination thereof. Processes can communicate using a variety of techniques including but not limited to conventional techniques for inter-process communication, and different pairs of processes may use different techniques, or the same pair of processes may use different techniques at different times.

Any of the software components or functions described in this disclosure may be implemented as software code to be executed by a processor using any suitable computer language such as, for example, Java, C++ or Perl using, for example, conventional or object-oriented techniques. The software code may be stored as a series of instructions or commands on a computer readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like.

The above description of exemplary embodiments of the invention has been presented for the purposes of illustration and description. It is not intended to be exhaustive or to limit the invention to the precise form described, and many modifications and variations are possible in light of the teaching above. The embodiments were chosen and described in order to clearly explain the principles of the invention and its practical applications to thereby enable others skilled in the art to best utilize the invention in various embodiments and with various modifications as are suited to the particular use contemplated. The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims.

What is claimed is:

1. A method comprising:
receiving, by a computing system comprising one or more processors, a request from a first user to share an application on a first computing device with a second user;
sending information regarding the request to a second computing device of the second user;
receiving an acknowledgement from the second computing device indicating acceptance of the request; and
responsive to the receiving the acknowledgement:
causing the application to be downloaded to the second computing device;
determining configuration data to be downloaded to the second computing device, the configuration data comprising at least one configuration setting whose value is set due to one or more interactions by the first user with the application on the first computing device; and
causing the configuration data to be sent to the second computing device.

2. The method of claim 1 wherein the configuration data to be downloaded to the second computing device comprises at least one change made to default configuration data downloaded to the first computing device when the first application was downloaded to the first computing device.

3. The method of claim 1 wherein the configuration data to be downloaded to the second computing device comprises a first configuration setting that is assigned a particular value by the first user.

4. The method of claim 1 wherein, subsequent to causing the configuration data to be sent to the second computing device, the configuration data on the first computing device is modified independently from the configuration data on the second computing device.

5. The method of claim 1 further comprising:
automatically creating, by the computing system, an account for the second user; and
associating, by the computing system, the configuration data with the account.

6. The method of claim 1 further comprising:
communicating the request from the first computing device to the computing system upon detecting, by the first computing device, a gesture performed by the first user with respect to the application.

7. The method of claim 1 further comprising:
determining, by the computing system, prior to causing the application to be downloaded to the second computing device, that the application does not exist on the second computing device.

8. The method of claim 1 further comprising:
installing the downloaded application on the second computing device; and
applying the downloaded configuration data to the installed application on the second computing device.

9. A system comprising:
one or more processors; and
memory coupled to the one or more processors, the memory encoded with a set of instructions comprising instruction, which when executed by the one or more processors, cause the one or more processors to:
receive a request from a first user to share an application on a first computing device with a second user;
send information regarding the request to a second computing device of the second user;
receive an acknowledgement from the second computing device indicating acceptance of the request; and
responsive to the receiving the acknowledgement:
cause the application to be downloaded to the second computing device;
determine configuration data to be downloaded to the second computing device, the configuration data comprising at least one configuration setting whose value is set due to one or more interactions by the first user with the application on the first computing device; and
cause the configuration data to be sent to the second computing device.

10. The system of claim 9, wherein the configuration data to be downloaded to the second computing device comprises at least one change made to default configuration data downloaded to the first computing device when the first application was downloaded to the first computing device.

11. The system of claim 9, wherein the configuration data to be downloaded to the second computing device comprises a first configuration setting that is assigned a particular value by the first user.

12. The system of claim 9, wherein subsequent to causing the configuration data to be sent to the second computing device, the configuration data on the first computing device is modified independently from the configuration data on the second computing device.

13. The system of claim 9, wherein the set of instructions further comprising instructions, which when executed by the one or more processors, cause the one or more processors to:
automatically create an account for the second user; and
associate the configuration data with the account.

14. The system of claim 9, wherein the set of instructions further comprising instructions, which when executed by the one or more processors, cause the one or more processors to:
communicate the request from the first computing device to the computing system upon detecting, by the first computing device, a gesture performed by the first user with respect to the application.

15. The system of claim 9, wherein the set of instructions further comprising instructions, which when executed by the one or more processors, cause the one or more processors to:
determine prior to causing the application to be downloaded to the second computing device, that the application does not exist on the second computing device.

16. A non-transitory computer readable storage memory storing a plurality of instructions that when executed by one or more processors, cause the one or more processors to perform operations comprising:
receiving a request from a first user to share an application on a first computing device with a second user;
sending information regarding the request to a second computing device of the second user;
receiving an acknowledgement from the second computing device indicating acceptance of the request; and
responsive to the receiving the acknowledgement:
causing the application to be downloaded to the second computing device;
determining configuration data to be downloaded to the second computing device, the configuration data comprising at least one configuration setting whose value is set due to one or more interactions by the first user with the application on the first computing device; and
causing the configuration data to be sent to the second computing device.

17. The computer readable storage memory of claim 16 wherein the configuration data to be downloaded to the second computing device comprises at least one change made to default configuration data downloaded to the first computing device when the first application was downloaded to the first computing device.

18. The computer readable storage memory of claim 16, wherein subsequent to causing the configuration data to be sent to the second computing device, the configuration data on the first computing device is modified independently from the configuration data on the second computing device.

19. The computer readable storage memory of claim 16, wherein the instructions further cause the one or more processors to perform operations comprising:
automatically creating an account for the second user; and
associating the configuration data with the account.

20. The computer readable storage memory of claim 16, the instructions further cause the one or more processors to perform operations comprising:
determining, prior to causing the application to be downloaded to the second computing device, that the application does not exist on the second computing device.
